(19) United States
(12) Patent Application Publication
(10) Pub. No.: US 2003/0230019 A1
(43) Pub. Date: Dec. 18, 2003

(54) Container identifier and method for identifying containers

(76) Inventor: Luis Antonio Arroyo Olivera, Chicago, IL (US)

Correspondence Address: JoAnne M. Denison, 212 W. Washington Blvd., Suite 1608, Chicago, IL, 60606-3487, US

(21) Appl. No.: 10/172,681

(22) Filed: Jun. 14, 2002

(51) Int. Cl. G09F 3/14; G09F 3/00

(52) U.S. Cl. 40/665; 40/306; 40/310

(57) ABSTRACT

A container identifier and method for identifying containers are provided. The container identifier may have a tab and a slit. The tab on the container identifier may have a grip located between the tab and in contact with the container. The container identifier distinguishes between beverage containers and, by use of the slit, may be adjusted to fit different size containers. The identifier may fit a container, such as, for example, a bottle or a can to identify a user of the container. The identifier may be shaped as a ring-like object, a helmet, an animal or the like. Further, the identifier may have indicia relating to, for example, products, a school, a team, an organization or the like.

### BACKGROUND OF THE INVENTION

The present invention generally relates to a container identifier and a method for identifying containers. More specifically, the present invention relates to an identifier and method for distinguishing between beverage containers. The identifier may fit a container, such as, for example, a bottle or a can to distinguish the bottle or can from other similar bottles or cans. The identifier may be a ring-like object which may be attached to the container.

It is, of course, generally known to provide a holding and/or identification device for bottles, cans, and the like. For example, U.S. Pat. No. 6,293,034 to Skapyak et al. discloses a wine bottle ring for placing around a neck of the wine bottle. In addition, wine glass rings are known for placing around a stem of a wine glass. The wine glass rings may provide a distinctive ornamentation to distinguish the wine glasses from each other. The distinctive ornamentation may be through shape, color, size, or any other manner where it may be possible to see that one of the rings is clearly different from any one of the other rings.

U.S. Pat. No. 5,358,770 to Evans discloses a device releasably clasped to a container which provides for personal identification of the container. The device has an enlarged central region for receiving advertising as well as for receiving indicia relating to the personal identification.

Further, U.S. Pat. No. 3,813,801 to Vander Schaaf discloses a device to wrap around a can. The device has an exposed surface having printed advertising matter or other matter, such as, for example, decorative matter, comical matter, distinguishing colors and/or numbers and the like.

Still further, U.S. Pat. No. 5,799,815 to Lang relates to a device for identifying pop-top cans. The device includes a flexible resilient sleeve which slides over and sits on the free end of the pop-top can tab. The sleeve has a distinctive color, design, texture, written indicia or any combination thereof to identify the can.

However, the known devices fail to expand to fit different sized beverage containers and/or more than one size container. For example, the known devices may fit a can or bottle having a 2½-inch diameter, but may not be used again on a bottle having a diameter of three or more inches. Further, the known devices fail to include a gripping mechanism such that the identifier is not easily removed and/or lost.

A need, therefore, exists for a container identifier for cans, bottles, glasses, and the like that may adjust for the size of a container and/or that grips to the container to prevent movement and/or loss of the identifier.

### SUMMARY OF THE INVENTION

The present invention generally relates to a container identifier and a method for identifying containers. More specifically, the present invention relates to an identifier and a method for distinguishing between beverage containers. The identifier may fit a container, such as, for example, a bottle or a can to distinguish the bottle or can from other similar bottles or cans. The identifier may be a ring-like object which may be attached to the container.

To this end, in an embodiment of the present invention, an identifier for a container is provided having a body, a tab extending from the body and an opening. The body has a cylindrical shape and a height defined between a top end and a bottom end. The body has a first side facing the container and a second side opposite the first side. The tab extends from the body and the tab contacts the container. The opening is in the body and has a width. The opening extends through the height of the body and the opening is separable to increase the width of the opening.

In another embodiment, the identifier has a protrusion on the tab wherein the protrusion extends from the tab to contact the container.

In another embodiment, the identifier has a pad attached to the tab between the tab and the container.

In another embodiment, the identifier has foam attached to the tab between the tab and the container.

In another embodiment, the identifier has rubber attached to the tab between the tab and the container.

In another embodiment, the identifier has an adhesive on the tab.

In another embodiment, the identifier has indicia on the body.

In another embodiment, the identifier has a color associated with the body.

In another embodiment, the cylindrical shape of the body is a helmet.

In another embodiment of the present invention, a method for distinguishing one container from another container is provided. The method has the steps of: providing a body having a height defined between a top end and a bottom end wherein the body has a first side facing the container and a second side opposite the first side; providing a tab extending from the body; attaching a grip to the tab between the tab and the container wherein the grip contacts the container; and placing the body on the container wherein the grip holds to the container.

In another embodiment, the method for distinguishing one container from another container further comprises the step of providing an opening in the body having a width wherein the opening extends through the height of the body and further wherein the opening is separable to increase the width of the opening.

In another embodiment, the method for distinguishing one container from another container further comprises the step of adding indicia on the body to distinguish the body.

In another embodiment, the body has printed information.

In another embodiment, the body has a color.

In another embodiment, the method for distinguishing one container from another container further comprises the step of attaching a pad to the first side of the body.

In another embodiment, the method for distinguishing one container from another container further comprises the step of attaching foam to the tab between the tab and the container.

In another embodiment, the method for distinguishing one container from another container further comprises the step of attaching rubber to the tab between the tab and the container.

In another embodiment, the method for distinguishing one container from another container further comprises the step of expanding the body to place the body on a larger container.

In another embodiment, the body has a shape of a helmet.

It is, therefore, an advantage of the present invention to provide a container identifier and a method for identifying a beverage container of a user.

Another advantage of the present invention is to provide a container identifier and a method for identifying a container to prevent mistaking the beverage container of one with another.

Yet another advantage of the present invention is to provide a container identifier and a method for identifying a container to help in the prevention of the transmission of germs that lead to sickness and diseases by distinguishing one container from another.

A further advantage of the present invention is to provide a container identifier and a method for identifying a container to limit the problem of unfinished or lost beverages.

A still further advantage of the present invention is to provide a container identifier and a method for identifying a container that allows for advertising.

Another advantage of the present invention is to provide a container identifier and a method for identifying a container that allows for the display of different colors or logos associated with a favorite team, school, or the like.

Additional features and advantages of the present invention are described in, and will be apparent from, the detailed description of the presently preferred embodiments and from the drawings.

### BRIEF DESCRIPTION OF THE DRAWINGS

FIG. 1 is side view of an embodiment of a container identifier of the present invention.

FIG. 2 is a bottom view of an embodiment of a container identifier of the present invention.

FIG. 3 is a side view of an embodiment of a container identifier of the present invention.

FIG. 4 is perspective view of a container identifier used on a bottle in an embodiment of the present invention.

FIG. 5 is perspective view of an embodiment of a container identifier of the present invention.

FIG. 6 is perspective view of an embodiment of a container identifier of the present invention as used on a beverage can.

### DETAILED DESCRIPTION OF THE PRESENTLY PREFERRED EMBODIMENTS

The present invention generally relates to a container identifier and a method for identifying containers. More specifically, the present invention relates to an identifier and a method for distinguishing between beverage containers. The identifier may fit a container, such as, for example, a bottle or a can to distinguish the bottle or can from other similar bottles or cans. The identifier may be a ring-like object which may be attached to the container.

Referring now to the drawings wherein like numerals refer to like parts, FIGS. 1 illustrates a container identifier 10 of the present invention. Preferably, the container identifier 10 may be constructed of plastic, but may be constructed of other materials, such as, for example, any metal, such as aluminum or steel, cardboard, paper, or the like.

The container identifier 10 may have a ring-like shape and may have a top portion 12 and a bottom portion 14. The top portion 12 may be defined between a first end 16 and a second end 18. The first end 16 may have a diameter smaller than a diameter of the second end 18 such that the top portion 12 may taper from the first end 16 to the second end 18. The second end 18 of the top portion 12 may be attached to the bottom portion 14 of the container identifier 10. Preferably, the top portion 12 and the bottom portion 14 are integrally formed. As also shown in FIG. 1, the container identifier 10 may have a wing 20.

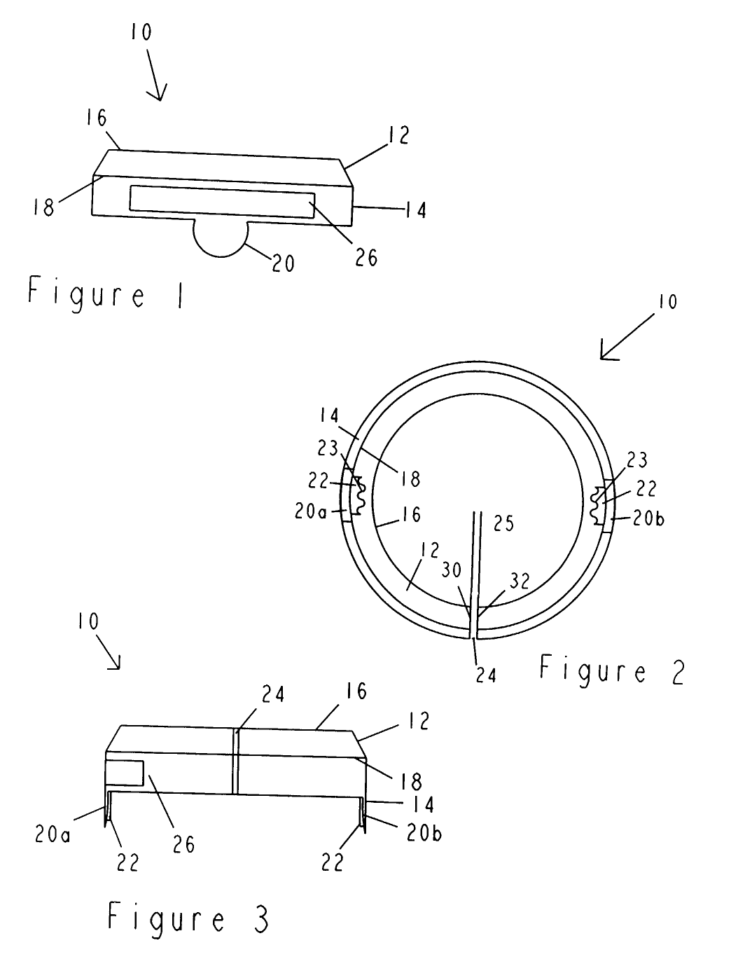

Referring to FIG. 2, the first end 16 and the second end 18 of the top portion 12, as well as the bottom portion 14, the wing 20 and the tab 22 are illustrated in a bottom view of an embodiment of the container identifier 10 of the present invention. As shown in FIG. 2, the wing 20 may have a tab 22 under the wing 20. The tab 22 may be constructed from, for example, foam, rubber, adhesive material or the like. In another embodiment, instead of foam, rubber, or the like, the tab 22 may have a ripple or protrusion 23 to secure the container identifier 10 against the bottle or can. As also shown in FIG. 2, the container identifier 10 may have more than one wing 20 and more than one tab 22. The container identifier 10 may have a first wing 20a and a second wing 20b at, for example, opposite from each other. More specifically, the first wing 20a may depend from the bottom portion 14 of the container at a location opposite from the second wing 20b. Further, the container identifier 10 may have a slit 24 through the top portion 12 and the bottom portion 14. The slit 24 may have a width 25. The slit 24 may allow the container identifier 10 to expand. Accordingly, the container identifier 10 may expand to fit various sizes of beverage containers.

Referring to FIG. 3, a side view of the container identifier 10 is illustrated. The container identifier 10, as illustrated in FIG. 3, may have indicia 26, for advertisement or identification, such as a number, color, name, or the like. The indicia 26 may allow a user to distinguish his/her can or bottle from other similar cans or bottles. For example, the indicia 26 may include the name of the user, such as, for example, the name “John”. The user may distinguish his can or bottle from other similar cans or bottles by the name “John” on the container identifier 10. In another example, the indicia 26 on the container identifier 10 may include a team name and/or mascot, such as, for example, “Butler Vikings”. Another container identifier 10 may have indicia 26 including, for example, the team name and mascot, such as, for example, “Hinsdale Red Devils”. Accordingly, the container identifier 10 with the indicia 26 including “Butler Vikings” may distinguish a can or a bottle from a similar can or similar bottle having a container identifier 10 with the indicia 26 including “Hinsdale Red Devils”.

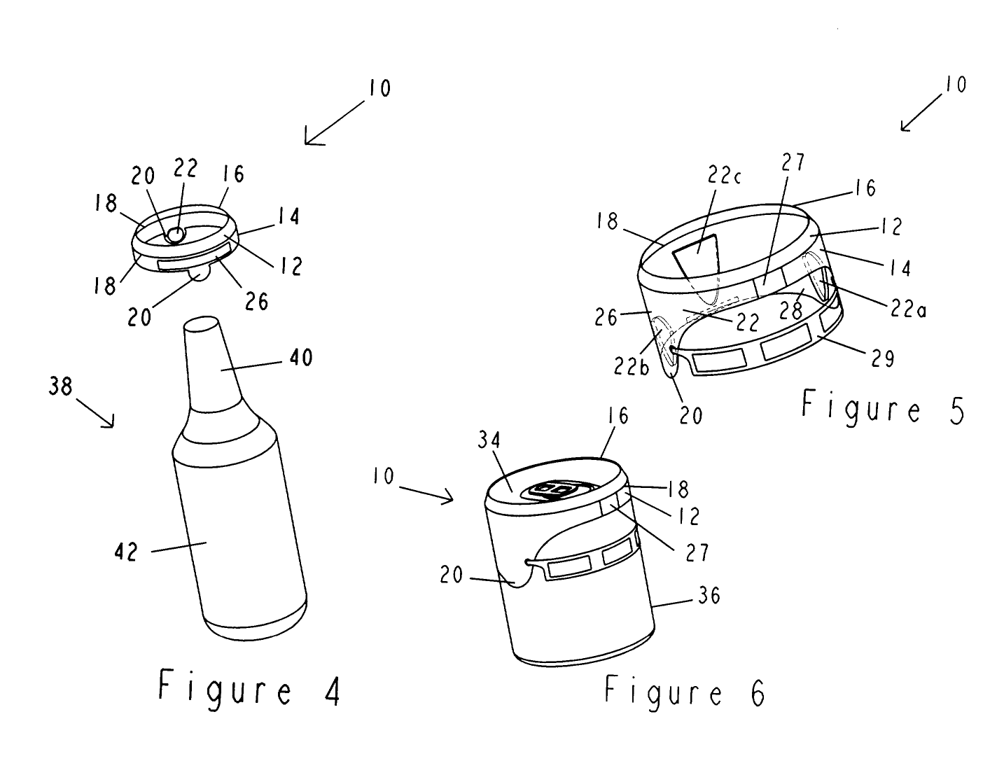

Referring to FIG. 4, a perspective view of the container identifier 10 is illustrated. In use, the container identifier 10 may be placed on a bottle 38. The container identifier 10 may be placed on the bottle 38 by placing the container identifier 10 over a neck 40 of the bottle. After the container identifier 10 is placed over the neck 40 of the bottle 38, the container identifier 10 may be placed onto a body 42 of the bottle. The diameter of the container identifier 10 may be substantially similar to the diameter of the bottle 38, such that the container identifier 10 hugs the bottle 38. The tab 22 on the wing 20 of the container identifier 10 may provide friction between the tab 22 and the bottle 38. As a result, the container identifier 10 may be substantially held in a position on the bottle 38 and may be prevented from moving or falling off the bottle 38.

In an embodiment of the present invention, the container identifier 10 may be shaped as a helmet, a baseball cap, a school mascot, a cartoon character, an animal, or the like. Referring to FIG. 5, in an embodiment, the container identifier 10 may replicate a helmet of a football player, football team, or the like. The container identifier 10 may have indicia 26 including a team name, team color, player number, and/or the like. The container identifier 10 may have decorative pieces 29 for further replicating a shape of a helmet, such as, for example, a face mask. Of course, the container identifier 10 may be shaped as various items and characters and may have various decorative pieces. For example, the container identifier 10 may be shaped in the form of a rabbit (not shown) and may have decorative pieces including rabbit ears, rabbit nose or the like.

As further shown in FIG. 5, the container identifier 10 may have a third tab 22c as well as the first tab 22a and the second tab 22b. The first tab 22a may be associated with the wing 20. The third tab 22c may be associated with an interior surface 28 of the container identifier 10. The first tab 22a, the second tab 22b, and the third tab 22c may be various sizes and/or shapes.

Referring to FIG. 6, in another embodiment, the container identifier 10 is shown in use, positioned on a can 36. The container identifier 10 may be placed with the container identifier 10 on, for example, the can 36 by placing the container identifier 10 over a top end 34 of the can 36 as shown in FIG. 6. The first end 16 of the top portion 12 of the container identifier 10 may rest on the top end 34 of the can 36. The tab 22 may further secure the container identifier 10 to the can 36. In use, the container identifier 10 may have a distinguishing color, logo, word or the like to distinguish one container, such as, for example, a bottle or can, from another container.

In an embodiment of the present invention, the container identifier 10 may be used to identify multiple containers. For example, the container identifier 10 may be used at any gathering of people where numerous beverage containers may be used by individuals at the same time, such as, for example, a party, at an office or other place of work, at meetings, or the like. At a party, for example, numerous individuals may be drinking from similar bottles. An individual may confuse his beverage container with the beverage container of another and may expose himself to bacteria or germs by drinking from the beverage container of another. Further, an individual may lose track of his beverage container and may choose to use a second beverage container thereby wasting the remaining beverage in his first beverage container. To avoid loss of his beverage container, the individual may use the container identifier 10.

To use the container identifier 10, the individual may first choose the container identifier 10 that is distinct from the beverage container to uniquely identify his beverage container. Alternatively, the individual may add indicia to the container identifier 10 to further distinguish the container identifier 10. The individual may add indicia to the beverage container by marking the beverage container with a pen, marker, or the like. Alternatively, the individual may choose the container identifier 10 with indicia that is unique to that container identifier 10.

Second, the individual may attach the container identifier 10 to his beverage container. If the diameter of the beverage container is larger than the diameter of the container identifier 10, the individual may expand the container identifier 10 to fit the beverage container. Finally, the individual may recycle the container identifier 10. For example, if the individual chooses to use a second or different beverage container, the individual may remove the container identifier 10 from the beverage container and re-attach the container identifier 10 to the second or different beverage container.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An identifier for a container, the identifier comprising:
a body having a cylindrical shape and a height defined between a top end and a bottom end wherein the body has a first side facing the container and a second side opposite the first side;
a tab extending from the body wherein the tab contacts the container; and
an opening in the body having a width wherein the opening extends through the height of the body and further wherein the opening is separable to increase the width of the opening.

2. The identifier of claim 1 further comprising:
a protrusion on the tab wherein the protrusion extends from the tab to contact the container.

3. The identifier of claim 1 further comprising:
a pad attached to the tab between the tab and the container.

4. The identifier of claim 1 further comprising:
foam attached to the tab between the tab and the container.

5. The identifier of claim 1 further comprising:
rubber attached to the tab between the tab and the container.

6. The identifier of claim 1 further comprising:
an adhesive on the tab.

7. The identifier of claim 1 further comprising:
indicia on the body.

8. The identifier of claim 1 further comprising:
a color associated with the body.

9. The identifier of claim 1 wherein the cylindrical shape of the body is a helmet.

10. A method for distinguishing one container from another container, the method comprising the steps of:
providing a body having a height defined between a top end and a bottom end wherein the body has a first side facing the container and a second side opposite the first side;
providing a tab extending from the body;
attaching a grip to the tab between the tab and the container wherein the grip contacts the container; and
placing the body on the container wherein the grip holds to the container.

11. The method of claim 10 further comprising the step of:
providing an opening in the body having a width wherein the opening extends through the height of the body and further wherein the opening is separable to increase the width of the opening.

12. The method of claim 10 further comprising the step of:
adding indicia on the body to distinguish the body.

13. The method of claim 10 wherein the body has printed information.

14. The method of claim 10 wherein the body has a color.

15. The method of claim 10 further comprising the step of:
attaching a pad to the first side of the body.

16. The method of claim 10 further comprising the step of:
attaching foam to the tab between the tab and the container.

17. The method of claim 10 further comprising the step of:
attaching rubber to the tab between the tab and the container.

18. The method of claim 10 further comprising the step of:
expanding the body to place the body on a larger container.

19. The method of claim 10 wherein the body has a shape of a helmet.
